(19) United States
(12) Patent Application Publication
(10) Pub. No.: US 2024/0426733 A1
(43) Pub. Date: Dec. 26, 2024

(54) Measuring Rock Permeability

(71) Applicant: Saudi Arabian Oil Company, Dhahran (SA)

(72) Inventors: Bander S. Al-Malki, Dammam (SA); Mohammed F. Al-Atigue, Dammam (SA); Faisal M. Sarawi, Dhahran (SA)

(21) Appl. No.: 18/339,674

(22) Filed: Jun. 22, 2023

(51) Int. Cl. G01N 15/08

(52) U.S. Cl. CPC G01N 15/0826; G01N 15/0806

(57) ABSTRACT

Systems, methods, and devices for measuring rock permeability include a sidewall coring tool including a sidewall coring unit and a sample testing chamber. The sample testing chamber is configured to receive a core sample from the sidewall coring unit. A supply of nitrogen gas is fluidly coupled to the sample testing chamber; and a sensor is configured to measure one or more properties of the nitrogen gas within the sample testing chamber.

### TECHNICAL FIELD

The present disclosure relates to measuring permeability of a rock from a subsurface formation.

### BACKGROUND

In the oil and gas industry, wells are drilled into subsurface formations. Rock properties of the subsurface formation affect hydrocarbon extraction activities and development strategies for current and future wells. Permeability is an important rock property that affects the volume and rate that fluids are transported through the rock. Conventionally, core samples are obtained from a well, and the permeability is measured in a laboratory setting.

### SUMMARY

This disclosure describes systems and methods for obtaining sidewall core samples from a wellbore and analyzing the samples in-situ to determine a permeability of the core samples. A wireline tool obtains a core sample from the sidewall of a wellbore. The core sample is retrieved into the tool. The core sample is placed in a sample testing chamber where a flow of nitrogen gas is used to determine the permeability of the sample in real time.

In one aspect, a sidewall coring tool includes a sidewall coring unit; a sample testing chamber configured to receive a core sample from the sidewall coring unit; a supply of nitrogen gas fluidly coupled to the sample testing chamber; and a sensor configured to measure one or more properties of the nitrogen gas within the sample testing chamber.

In one aspect, a method for measuring permeability in a wellbore includes obtaining a core sample from a sidewall of the wellbore; conveying the core sample from a sidewall coring unit to a sample testing chamber included in a body of a sidewall coring tool; activating a flow of nitrogen gas in the sample testing chamber; and measuring a permeability of the core sample based on the flow of nitrogen gas.

Implementations of these aspects can include one or more of the following features.

In some implementations, the sensor includes at least one of a pressure sensor and a flow rate sensor.

In some implementations, these aspects include a sample storage container coupled to the sample testing chamber.

In some implementations, these aspects include an activation switch configured to start a flow of nitrogen gas from the supply of nitrogen gas.

In some implementations, the activation switch includes a spring configured to be compressed by movement of a core sample.

In some implementations, these aspects include one or more valves configured to regulate a flow of nitrogen gas from the supply of nitrogen gas entering and exiting the sample testing chamber.

In some implementations, these aspects include a controller including at least one processor; and a memory storing instructions that, when executed by the at least one processor, cause the at least one processor to perform operations including obtaining a core sample from a sidewall of a wellbore; conveying the core sample from a sidewall coring unit to a sample testing chamber comprised in a body of a sidewall coring tool; activating a flow of nitrogen gas in the sample testing chamber; and measuring a permeability of the core sample based on the flow of nitrogen gas.

In some implementations, the operations further include transmitting the measured permeability to a data processing system external to the sidewall coring tool.

In some implementations, measuring a permeability includes measuring a flow rate of the nitrogen gas at a specified pressure differential across the core sample.

In some implementations, measuring a permeability includes measuring a pressure differential across the core sample at a specified flow rate of nitrogen gas.

In some implementations, these aspects include transmitting the measured permeability to a data processing system located outside the wellbore.

In some implementations, activating a flow of nitrogen gas includes activating a mechanical switch by movement of the core sample.

In some implementations, activating the flow of nitrogen gas includes receiving an electronic signal to activate an electronic switch.

In some implementations, these aspects include conveying the core sample from the sample testing chamber to a storage container comprised in the body of the sidewall coring tool.

Implementations of the systems and methods of this disclosure can provide various technical benefits. These systems and methods measure the permeability of the subsurface formation in real time. The permeability is measured from samples in their original condition. Handling of the samples prior to measurement is reduced. The systems and methods can provide immediate reservoir characterization which can be used to evaluate reservoir condition and rock properties that can be used, for example, to tailor the drilling mud rheology to the specific rock properties of the reservoir and to decrease formation fluid sampling time.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic illustrating a wireline operation.

FIG. 2 illustrates a schematic of a sidewall coring tool with in-situ permeability measurements.

FIG. 3 illustrates a schematic of a core sample testing chamber of a sidewall coring tool.

FIG. 4 shows example data for in-situ permeability measurements.

FIG. 5 is a flow chart for a method for measuring permeability of core samples.

FIG. 6 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for obtaining side wall core samples from a wellbore and analyzing the samples within the sidewall coring tool to determine a permeability of the core samples. A wireline tool obtains a core sample from the sidewall of a wellbore. The core sample is retrieved into the tool. The core sample is placed in a sample testing chamber where a flow of nitrogen gas is used to determine the permeability of the sample in real time.

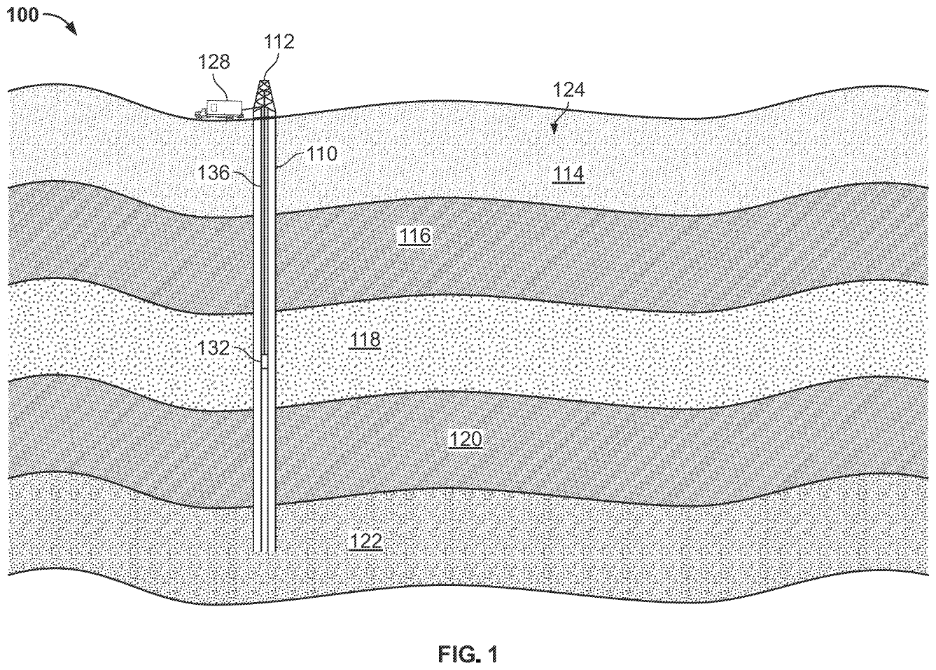

FIG. 1 illustrates a wireline operation 100 (e.g., a well logging operation) in which a wellbore 110 extends downhole from a wellhead 112. The wellbore 110 is a vertical wellbore but wireline operations can also be performed in other wellbores, for example, slanted or horizontal wellbores. In the wireline operation 100, the wellbore 110 penetrates through five layers 114, 116, 118, 120, 122 of a subsurface formation 124. A control truck 128 lowers a logging tool 132 (e.g., a sidewall coring tool) down the wellbore 110 on a wireline 136.

The logging tool 132 is string of one or more instruments with sensors operable to measure petrophysical properties of the subsurface formation 124. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which typically a function of lithology and rock texture but particularly porosity. The logging tool includes a piezoelectric transmitter and receiver and the time taken for the sound wave to travel the fixed distance between the two is recorded as an interval transit time.

As the logging tool 132 travels downhole, measurements of formations properties are recorded to generate a well log. In the illustrated operation, the data are recorded at the control truck 128 in real-time. Real-time data are recorded directly against measured cable depth. In some well-logging operations, the data is recorded at the logging tool 132 and downloaded later. In this approach, the downhole data and depth data are both recorded against time The two data sets are then merged using the common time base to create an instrument response versus depth log.

In the wireline operation 100, the well logging is performed on a wellbore 110 that has already been drilled. In some operations, well logging is performed in the form of logging while drilling techniques. In these techniques, the sensors are integrated into the drill string and the measurements are made in real-time, during drilled rather using sensors lowered into a well after drilling.

Using a wireline coring tool, core samples can be obtained in addition to obtaining well logs. A core sample is a usually cylindrical piece of the subsurface formation that is removed by a special drill and brought to the surface. Core samples can be used to measure petrophysical properties of the subsurface formation such as grain size, porosity, and permeability. Core samples can be taken from the sidewalls of a drilled well. When sidewall core samples are repeated along the length of the well, the properties measured from the core samples can be compared and correlated with well logging measurements.

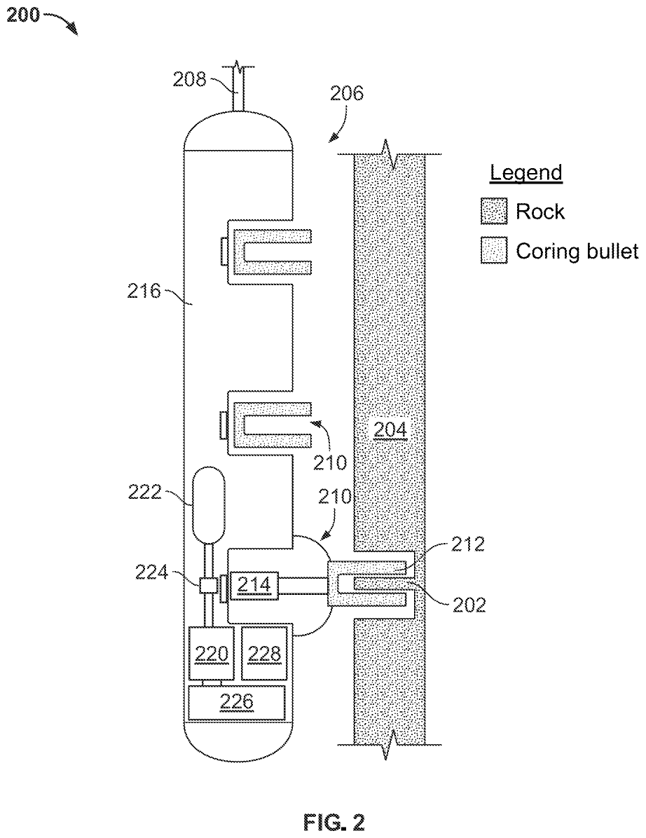

FIG. 2 illustrates a schematic of an example wireline sidewall coring tool 200 that can acquire core samples 202 from the sidewalls 204 of a wellbore 206. The sidewall coring tool 200 includes a wireline attachment 208. The wireline attachment 208 can be used to raise, lower, and suspend the sidewall coring tool 200 in a wellbore 206. The wireline attachment can also provide electrical power and data communication between the sidewall coring tool 200 and the wireline control truck (e.g., 128).

The sidewall coring tool includes one or more sidewall coring units 210. The sidewall coring units 210 include a coring mechanism 212. The coring mechanism 212 can be, for example, a rotary cutting mechanism or a coring bullet. The coring mechanism 212 is operable to cut cylindrical core samples from the sidewall 204 of the wellbore 206. In some implementations, the sidewall coring unit 210 includes a hydraulic assembly 214. The hydraulic assembly 214 is operable to extend and retract the coring mechanism 210 from the body 216 of the sidewall coring tool 200. The hydraulic assembly 214 can be used to extract the core sample 202 from the coring mechanism 210 and position the core sample in a sample testing chamber 220.

The sample testing chamber 220 is operable to measure the permeability of the core samples 202 while the sidewall coring tool 200 is in the wellbore. The sample testing chamber 220 is fluidly connected to a supply of nitrogen gas 222. Nitrogen gas has minimal reactions with the source rock and other fluids present in the wellbore. The sample testing chamber 220 includes an activation switch 224 that is operable to start a flow of nitrogen gas from the supply of nitrogen gas 222. In some implementations, the activation switch 224 includes a mechanical spring that can be compressed by the core sample 202. In some implementations, the activation switch 224 includes an electronic switch that can be activated from the wireline control truck (e.g., wireline control truck 128). The sample testing chamber 220 can be configured to test multiple core samples while the sidewall coring tool 200 is in the wellbore 206.

In some implementations, the sidewall coring tool 200 additionally includes a downhole pump configured to pump a liquid across the core sample in the sample testing chamber 220. The sample testing chamber 220 can include a reservoir to capture the liquid pumped through the core sample and any fluids that were contained in the core sample. The sensors 236 and 238 can be adapted to measure liquid properties of the liquid being pumped across the core sample. Alternatively, or additionally, more sensors can be included in the sample testing chamber.

The sidewall coring tool 200 further includes a sample storage chamber 226. The sample storage chamber 226 is configured to receive core samples from the sample testing chamber 220 after the permeability test has been conducted. The sample storage chamber 226 can store the core samples 202 for retrieval when the sidewall coring tool 200 is removed from the wellbore 206. The samples held within the sample storage chamber 226 can be transported to a laboratory for further analysis and testing. Fluids included in the core sample can be collected and stored in the sample storage chamber 226. Fluid samples can include samples of gas, water, and oil from the formation. The fluid samples can be tested in a laboratory setting at a later time.

In some implementations, the sidewall coring tool 200 includes a controller 228. The controller 228 includes one or more processors and memory storing instructions for operating the sidewall coring unit 210 and the sample testing chamber 220. The controller can be configured to transmit to and receive data from a wireline control truck (e.g., 128).

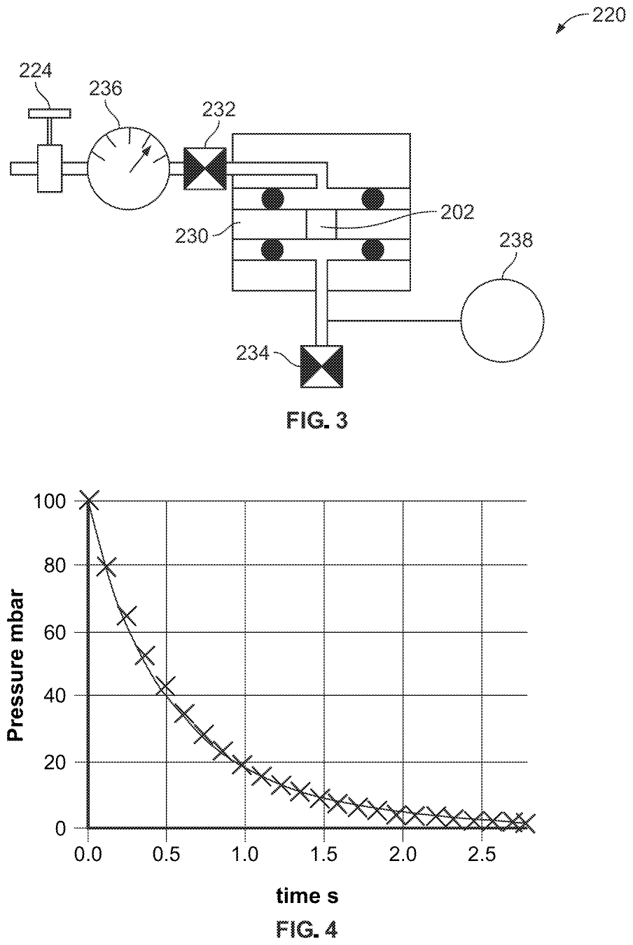

FIG. 3 illustrates a schematic of an example sample testing chamber 220. A core sample 202 is received into a core sample holder 230. The activation switch 224 enables the flow of nitrogen gas to the sample testing chamber 220. Valves 232, 234 are operable to control the flow of nitrogen gas into and out of the sample testing chamber 220. The sample testing chamber 220 includes one or more sensors 236, 238 to measure properties of the nitrogen gas. For example, a pressure gauge (e.g., 236) or pressure transducer can be installed upstream of the sample testing chamber 220 to measure the source pressure of the nitrogen gas. A second pressure sensor or a flow rate sensor (e.g., sensor 238) can be placed at the outlet of the sample testing chamber to measure a pressure drop across the core sample 202 or a flow rate through the core sample 202. During testing, nitrogen gas is injected into the core sample and the sensor measures at least one of the flow rate of nitrogen gas or a pressure of the nitrogen gas. After conducting the permeability measurements, the core sample is conveyed into a sample storage container 226. Core samples stored in the sample storage container 226 can be retrieved and transported to a lab after the sidewall coring tool is removed from the wellbore. The sensors 236, 238, valves 232, 234, and activation switch 224 can be connected to and controlled by the controller 228. The controller 228 can record the measurements and calculate the permeability of the core sample 202.

FIG. 4 shows an example plot 240 of data collected to measure permeability of a core sample. In plot 240, pressure versus time data is shown.

### Permeability can be Calculated According to Darcy's Law:

$$Q = - \frac{k A}{μ L} Δ P ,$$

where q is a flow rate through cross-sectional area A (e.g., cross-section of the core sample), k is the permeability, μ is the dynamic viscosity of the fluid, L is a length scale (e.g., length of the core sample), and ΔP is a pressure differential over the length L. The diameter of the core and the length of the core are known based on the configuration of the sidewall coring unit. In some implementations, a downhole scanner can be used to measure the dimensions of the sidewall core in situ to calculate the permeability with higher accuracy.

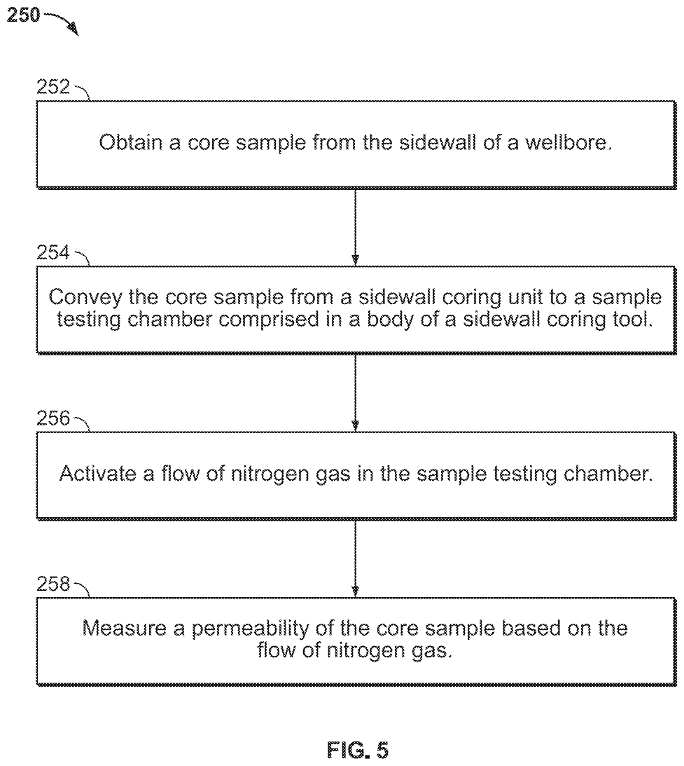

FIG. 5 is a flow chart of an example method 250 for measuring rock permeability in a wellbore. The method 250 provides a way to measure the permeability of a formation in real-time and in-situ while the coring tool is in the wellbore. In-situ measurements decrease the risk of potential damage that can occur to the core samples during collection, packaging, transportation, and preparation for laboratory permeability tests.

A core sample is obtained from the sidewall of a wellbore (252). The core sample can be obtained by, for example, the sidewall coring tool 200. The core sample has a specified diameter and length such that the core sample will fit with a sample testing chamber of the sidewall coring tool.

The core sample is conveyed from a sidewall coring unit to the sample testing chamber included in the body of the sidewall coring tool (254). A hydraulic assembly can be configured to remove the core sample from the sidewall coring unit and position the core sample for receipt into the sample testing chamber. In some implementations, multiple sample testing chambers associated with multiple sidewall coring units can be included in a single logging tool. The logging tool can collect and test multiple sidewall cores simultaneously.

A flow of nitrogen gas is activated in the sample testing chamber (256). The flow of gas is activated by an activation switch. In some implementations, the activation switch is a mechanical switch including a spring. The spring can be compressed by the core sample while the core sample is being conveyed to the sample testing chamber. In some implementations, the activation switch is an electronic switch that is activated by receiving an electronic signal. The electronic signal can be generated, for example, by a controller of the sidewall coring system or by an operator on the surface of the formation. The flow of nitrogen gas is allowed to reach steady state or stabilize at a specified flow rate. This can be determined based on the measured inlet and outlet pressures holding a constant value (or an approximately constant value with minor fluctuations around a central value such as fluctuations of 5 percent or less or 10 percent or less of the central value).

A permeability of the core sample is measured based on the flow of the nitrogen gas (258). One or more sensors within the sample testing chamber can measure properties of the nitrogen gas. For example, a sensor can measure a pressure downstream of the core sample or a flow rate of the nitrogen gas. In some implementations, both the pressure and the flow rate of the nitrogen gas are measured. In some implementations, a pressure differential across the core sample is fixed, and the flow rate required to maintain the pressure differential is measured. In some implementations, a flow rate of nitrogen gas injected into the core sample is fixed, and the pressure downstream of the core sample is measured.

In some implementations, the measured permeability is transmitted from the sidewall coring tool to a data processing system outside of the borehole (e.g., a control system of the wireline control truck). In some implementations, the controller stores a local copy of the measurements in the controller memory. The controller memory can be accessed after the sidewall coring tool is removed from the wellbore.

In some implementations, the method 250 is repeated for multiple core samples obtained from the same wellbore during a single run of the sidewall coring tool through the wellbore. The sample testing chamber is configured to receive the core samples from one or more sidewall coring units. After measuring the permeability of a core sample, the core sample is conveyed from the sample testing chamber to the sample storage chamber. The core can be disengaged from the sample testing chamber automatically at the conclusion of the permeability test. Alternatively, or additionally, the core can be disengaged upon receipt of an electronic signal from a controller or data processing system outside the well. The sample testing chamber can then receive the next core sample to test. This process can be repeated until the sample storage chamber is full. The volume of the storage chamber can be adapted to the size of the logging tool and the operational needs of the logging operation. Taking multiple core samples along the length of the wellbore trajectory can uncover heterogeneity of the subsurface formation. Such information is valuable for determining well completion strategies, production strategies, and locations for future wells to be drilled.

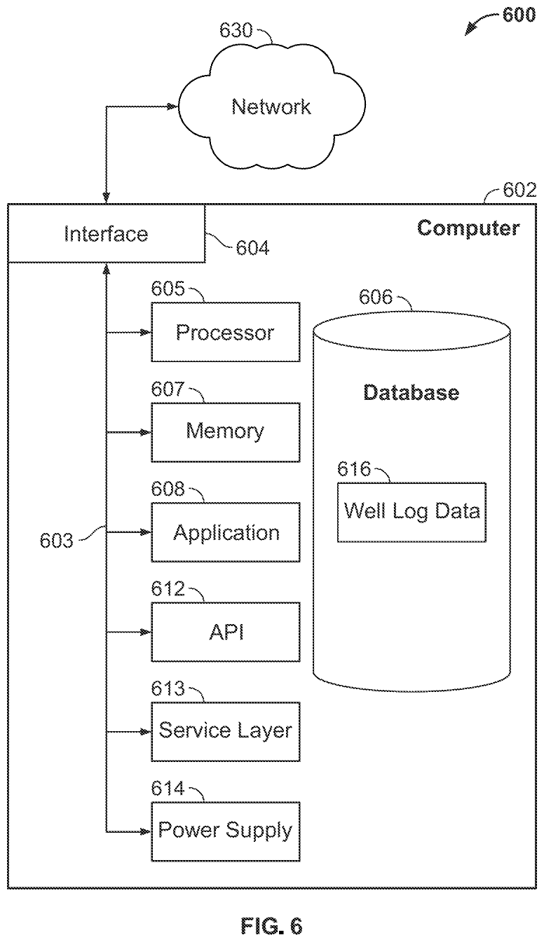

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A sidewall coring tool comprising:
a sidewall coring unit;
a sample testing chamber configured to receive a core sample from the sidewall coring unit;
a supply of nitrogen gas fluidly coupled to the sample testing chamber; and
a sensor configured to measure one or more properties of the nitrogen gas within the sample testing chamber.

2. The sidewall coring tool of claim 1, wherein the sensor comprises at least one of a pressure sensor and a flow rate sensor.

3. The sidewall coring tool of claim 1, further comprising:
a sample storage container coupled to the sample testing chamber.

4. The sidewall coring tool of claim 1, further comprising:
an activation switch configured to start a flow of nitrogen gas from the supply of nitrogen gas.

5. The sidewall coring tool of claim 4, wherein the activation switch comprises a spring configured to be compressed by movement of a core sample.

6. The sidewall coring tool of claim 1, further comprising:
one or more valves configured to regulate a flow of nitrogen gas from the supply of nitrogen gas entering and exiting the sample testing chamber.

7. The sidewall coring tool of claim 1, further comprising:
a controller comprising:
at least one processor; and
a memory storing instructions that, when executed by the at least one processor, cause the at least one processor to perform operations comprising:
obtaining a core sample from a sidewall of a wellbore;
conveying the core sample from a sidewall coring unit to a sample testing chamber comprised in a body of a sidewall coring tool;
activating a flow of nitrogen gas in the sample testing chamber; and
measuring a permeability of the core sample based on the flow of nitrogen gas.

8. The sidewall coring tool of claim 7, wherein the operations further comprise transmitting the measured permeability to a data processing system external to the sidewall coring tool.

9. A method for measuring permeability in a wellbore, comprising:
obtaining a core sample from a sidewall of the wellbore;
conveying the core sample from a sidewall coring unit to a sample testing chamber comprised in a body of a sidewall coring tool;
activating a flow of nitrogen gas in the sample testing chamber; and
measuring a permeability of the core sample based on the flow of nitrogen gas.

10. The method of claim 9, wherein measuring a permeability comprises measuring a flow rate of the nitrogen gas at a specified pressure differential across the core sample.

11. The method of claim 9, wherein measuring a permeability comprises measuring a pressure differential across the core sample at a specified flow rate of nitrogen gas.

12. The method of claim 9, further comprising:
transmitting the measured permeability to a data processing system located outside the wellbore.

13. The method of claim 9, wherein activating a flow of nitrogen gas comprises activating a mechanical switch by movement of the core sample.

14. The method of claim 9, wherein activating the flow of nitrogen gas comprises receiving an electronic signal to activate an electronic switch.

15. The method of claim 9, further comprising:
conveying the core sample from the sample testing chamber to a storage container comprised in the body of the sidewall coring tool.
